(19) United States
(12) Patent Application Publication
(10) Pub. No.: US 2019/0183141 A1
(43) Pub. Date: Jun. 20, 2019

(54) SYSTEMS AND METHODS FOR MODIFIED CONFECTIONARY ITEMS

(71) Applicant: Hesson, LLC, Neenah, WI (US)

(72) Inventor: Lynn A. Hesson, Neenah, WI (US)

(73) Assignee: Hesson, LLC

(21) Appl. No.: 16/217,409

(22) Filed: Dec. 12, 2018

Related U.S. Application Data
(60) Provisional application No. 62/598,879, filed on Dec. 14, 2017.

(51) Int. Cl. A23G 3/54; A23G 3/34; A23G 3/42

(52) U.S. Cl. CPC A23G 3/54; A23G 3/0089; A23G 3/42; A23G 3/343; A23G 2220/20; A23G 2200/14; A23V 2300/10; A23V 2002/00; A23V 2200/22; A23V 2250/6412; A23V 2250/21; A23V 2250/6422; A23V 2250/6402; A23G 2200/06

(57) ABSTRACT

The present disclosure provides systems and methods for binding active ingredients onto consumable high pressure gasified crystals. The method of binding dietary supplements, nutraceuticals, and active ingredients onto carbonated crystals (candy) can be performed to preserve the full benefits of the ingredients by using low or zero moisture, low or ambient temperatures, and ensuringeven dispersal of the ingredients per dosage. The supplements can be retained in the mouth of a user via sensory signals until orally absorbed.

### CROSS-REFERENCE TO RELATED APPLICATIONS

This application incorporates by reference and claims the benefit of priority to U.S. Provisional Application 62/598,879 filed on Dec. 14, 2017.

### BACKGROUND OF THE INVENTION

The present subject matter relates generally to confectionary items including active ingredients of medicants and/or dietary supplements.

Most oral delivery systems for medications and dietary supplements involve swallowing with subsequent absorption of the active ingredient(s) through the gastrointestinal (GI) system. Although this can be an effective means of delivery of many medications and dietary supplements, oral administration generally involves consuming a capsule, powder or liquid with water. Most medications and dietary supplements are not well-absorbed in the stomach and must transit into the gut for complete absorption.

For example, the active portion of drug and dietary supplements that enter the bloodstream may represent only a small fraction of the amount of active ingredient originally present in the oral product. Some individuals absorb only sub-therapeutic amounts of medicine and dietary supplements, whereas other individuals may absorb therapeutic amounts and some may absorb more active ingredient than is needed. Also, transit through the GI system requires a substantial amount of time and the degree of absorption of active ingredients can be dependent upon numerous factors, including dissolution times, gastric emptying time, amount of liquid present, and influence of food upon absorption. The time-delay for production of effective blood levels of active ingredients by the oral route generally ranges from 30 minutes to four hours. Therefore, relief of symptoms from cravings, pain, disease, ailments and conditions by oral medications and dietary supplements is substantially delayed. Sometimes, the amount of active ingredient delivered to the bloodstream is ineffectual, whereas sometimes too much active ingredient is delivered and avoidable side-effects may develop. Furthermore, the individual who is taking the medication(s) and dietary supplements has virtually no control over the amount or speed of delivery of active ingredient once the product has been swallowed.

Moreover, conventional forms of delivery of dietary supplements and nutraceuticals, including pills, tablets, gum, gummies, spray, drops, hard lozenges, candy, among others, are often not absorbed or digested by consumers. Further, conventional methods of delivery are also often less than effective for full delivery of benefits of dietary supplements and nutraceuticals as many elements of the supplement are not absorbed in the mouth.

Accordingly, because a majority of active ingredients are difficult for people to consume, there is a need for systems and methods of binding active ingredients that improve the ease and effectivity of consuming the active ingredient.

### BRIEF SUMMARY OF THE INVENTION

The present disclosure provides systems and methods for binding dietary supplements, nutraceuticals, and active ingredients onto confectionary items while preserving the full benefits of the ingredients by using low or zero moisture, low or ambient temperature, and dispersal of the ingredients per dosage. The ingredients are retained in the mouth via sensory signals until orally absorbed. Various examples of the systems and methods are provided herein.

In an example, the system provides modified confectionary items (e.g., carbonated crystals, popping candy, hard candy, mints, etc.) to form a homogeneous dose of active ingredients, which will be widely accepted by consumers providing fast absorption in a fun delivery.

In an example, the disclosure provides a modified confectionary item including a confectionary item, and a premix formulation coating a surface of the confectionary item, wherein the premix formulation includes a carrier and an active ingredient.

In an example, the disclosure provides a method of forming a modified confectionary item, the method including providing a confectionary item; applying an oil coating to a surface of the confectionary item; applying a premix formulation including an active ingredient and a carrier formulation to the oil coated confectionary item to form the modified confectionary item; and drying the modified confectionary item.

An advantage of the present system is providing a confectionary item to deliver active ingredients that can be orally absorbed, Absorption of active ingredient(s) through the oral mucosa into the bloodstream effectively bypasses the degradation that occurs in the gut wall and liver and provides an alternate means of providing active ingredients. Consequently, higher bioavailability of active ingredients may be achieved by transmucosal delivery than by oral ingestion.

A further advantage of the present system is providing a delivery method that is acceptable to young and adult consumers, while effectively delivering the benefits of dietary supplement and nutraceutical materials.

Another advantage of the present system is providing an edible supplement that includes ingredients that are immediately absorbed in a user's mouth instead of through the digestive system.

An advantage of the present system is providing a fun and tasty delivery mechanism of active ingredients for children.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### DETAILED DESCRIPTION OF THE INVENTION

The present disclosure provides binding dietary supplements, nutraceuticals, and/or active ingredients onto confectionary items (e.g., carbonated crystals, hard candy, popping candy, mints, gum, etc.) to form a homogeneous dose of active ingredients, wherein the confectionary provides fast absorption of the active ingredients in a fun delivery mechanism. In an example, the confectionary item includes carbonated candy including isomatl crystals.

In an example, the system provides modified confectionary items coated with a premix formulation including an active ingredient and carrier. The confectionary item can be any suitable item. For example, the confectionary item can include, but not limited to, hard candy, chew candy, popping candy, mints, lozenges, gum, lollipops, among others.

The active ingredients can be in any suitable form including, but not limited to, powdered actives, oil based actives, gel actives, among others. Further, the term “active ingredient” can include one or more active ingredients, materials, and/or blends.

In an example, the active ingredient is mixed with a carrier, e.g., an excipient. The carrier can be used for stabilization and/or bulking up solid formulations that contain an active ingredient in a small amount. The carrier can include bulking agents, fillers, diluents, emulsifiers, or combinations thereof. The excipient can include antiadherents, binders, coatings, colors, disintegrants, flavors, glidants, lubricants, preservatives, sorbents, sweeteners, and combinations thereof, among others. In an example, the carrier includes maltodextrin, dextrose, maltose, or combinations thereof.

Among the emulsifiers useful herein include, without limitation, alkyl aryl sultanates, alkyl sulfates, sulfonated amides and amines, sulfated and sulfanated esters and ethers, alkyl sulfonates, polyethoxylated esters, mono- and diglycerides, diactyl tartaric esters of monoglyderides, polyglycerol esters, sorbitan esters and ethoxylates, lactylated esters, propylene glycol esters, sucrose esters and mixtures thereof. Among the waxes useful herein include, without limitation, amorphous waxes, anionic emulsifying waxes, bleached waxes, caranda waxes, cetyl esters, cationic emulsifying waxes, microcrystalline waxes, paraffins, refined waxes and mixtures thereof.

The lubricant or lubricating material may be present in levels up to 15%, 12%, 10%, or 8% by weight of the final composition. Examples of usable lubricating materials include, without limitation, fats, emulsifiers, waxes, and mixtures thereof. Among the fats, or fatty materials, useful herein include, without limitation, water-insoluble, inert hydrocarbon fats or oils, or theft derivatives and mixtures thereof. Such fats or fatty materials include, for example and without limitation, cocoa butter, hydrogenated vegetable tallow, hydrogenated vegetable oils, and derivative mixtures thereof.

The carrier can be anhydrous or low moisture, wherein the carrier has a moisture content of less than 2.5%, less than 1.5%, less than 1%, and/or less than 0.5%. The excipient can be dried by any suitable means before mixing with the active ingredient formulation. For example, the carrier can be dried using heat, vacuum, desiccants, or combinations thereof.

The carrier and active ingredient can be mixed by any suitable methods to form the premix formulation. For example, the premix formulation can be formed by mixing the carrier and active ingredient in a ribbon blender to generate a fully mixed blend.

Gasified confectionary items can be placed in a standard confectionery coating pan. A spray device can be used to apply an inert coating oil to coat the gasified crystals in the pan to lightly coat the confectionary items. After the confectionary items are coated in oil, the premix formulation is gradually added to the wet crystals until the active ingredient formulation coats the confectionary items. Using temperature controlled forced air (e.g., between, and including, 60-85° F.), the coated confectionary item can be set to form the final modified confectionary items that can be removed from the pan and readied for consumer packaging. The dried confectionary items can be packaged in any suitable packaging, including, but not limited to, pouches, vials, sticks packs, wrappers, blister packs, among others. The dose of the supplement can be one or more packaging unit, and/or multiple doses can be within one unit.

The premix formulation can be solid or liquid. For example, the premix formulation can be a premix powder formulation and/or a premix oil formulation.

The premix powder formulation can be produced containing an even dispersion of a powdered active ingredient formulation and a powdered carrier formulation, to achieve the correct dose of active ingredients per packaged unit dose. A small batch ribbon blender can be used to achieve thorough mixing and proper dosage amounts. In an example, less than 15-18 percent of the final confectionary item can be the premix blend.

In an example, an inert binding solution can be evenly dispersed onto the confectionary item before the powdered dispersion is added, wherein the binding solution serves as a binding agent to attach the premix powder formulation evenly to the confectionary item. The binding solution can include inert oils such as sunflower oil, palm kernel oil, coconut oil, among others. Once the confectionary items are evenly coated with the binding solution, then the premix powder formulation can be evenly applied to the confectionary items to ensure correct final dosage. Once the proper dosage is confirmed, the coated confectionary items can be removed from the pan for final packaging.

For the premix oil formulation, the active ingredient and carrier are oil based. An inert oil can be used as a carrier for the oil based formulation, wherein the carrier oil is compatible with the active ingredient oil. Additional oils can be included in the oil based formulation including, but not limited to, flavor oils, color oils, among others.

The premix oil based formulation can be generated using a mixing device to fully mix the active ingredient oil, carrier oil, and any additives (e.g., oils used for flavor, color, and/or other therapeutic effects). A standard confectionery coating pan can be used to place the gasified confectionary items. A spray device can be used to apply the premix oil based formulation onto the confectionary item to coat the confectionary item. Temperature controlled air can be applied to the coated confectionary item to set (e.g., dry) the coating, such that the modified confectionary item can be removed and readied for consumer packaging.

With respect to the premix oil based formulations, the oil based active ingredient and oil based carrier can have a closely matched specific gravity. The oil based active ingredient and the oil based carrier can be blended together to form a homogeneous premix oil based formulation using a liquid blending device or mixer, and/or homogenizer. The premix oil based formulation can be evenly applied to the confectionary item to create the modified confectionary items. The coated confectionary items can be dried using chilled filtered air and made ready for final packaging into pouches, stick packs or other single serve dose packaging.

The modified confectionary items can have a base composed of a mixture of sugar and other carbohydrate bulking agents. Non-fermentable sugars such as sorbitol, mannitol, xylitol, isomalt and hydrogenated starch hydrolysates may also be used.

The modified confectionary items release active ingredients by dissolution in saliva. Dissolution times for lozenges and candies occur in the range of 1-10 minutes, preferably in the range of 1-5 minutes. Rapid release of the active ingredients from the coating of the modified confectionary item, occur initially because of stimulation of saliva flow by placement of the confectionary item in the mouth. The enhanced saliva flow hastens dissolution thereby effecting enhanced release of active ingredients.

The modified confectionary items can include sweeteners that constitute about 20-80% by weight of the confectionary items and may include both sugar and sugarless sweeteners. Such ingredients are well known in the art and are selected to impart improved palatability to the confectionary items and to aid in masking the bitter or unpleasant taste of some active ingredients. High intensity sweetners may also be included such as saccharin and its various salts, cyclamic acid and its various salts, sucralose, and other high-intensity sweeteners known in the art.

In addition, flavorants may be used in the modified confectionary items within the range of 0.1-10% by weight, preferably between about 0.5-4% by weight of the confectionary items. The flavoring agents may include natural and synthetic agents and all such combinations thereof. Colorants may include food and pharmaceutical grade coloring agents.

The amount of active ingredient used in each dose of edible supplement is dependent on the selected active ingredient. The dose can include one to ten supplements.

The active ingredients can be any suitable active ingredient. With respect to medicants and supplements, the active ingredient should be sufficiently water soluble to be released by the action of saliva and also should be sufficiently lipid-soluble to be absorbable through the oral mucosal tissues, i.e., buccal, sublingual, gingival and palatal tissues, Active ingredients of interest that display water-soluble properties generally contain polarizable chemical functional groups of the following types: a) amine groups; b) amide groups; c) carboxylic add groups; d) phenolic groups; and e) alcohol groups. Active ingredients can also be sufficiently lipid-soluble to allow passage through the epithelial tissues of the oral mucosa. Consequently, active ingredients that display molecular weights greater than 100 daltons and contain functional groups such as aromatic rings, cycloalkyl rings, heterocyclic rings, and hydrocarbon chains are generally sufficiently water soluble and lipid soluble for efficient absorption through epithelial tissues.

Exemplary of the many categories of active ingredients that are suitable for transmucosal delivery are anti-depressants, anti-diarrheals, anti-emetics, appetite enhancers, appetite suppressants, cough/cold medications, flu medicants, anti-diabetics, mental alertness enhancers, migraine/headache/fever medicants, anti-motion sickness medicants, nasal decongestants, analgesics, PMS medicants, sleep enhancers, sore throat medicants, cannabis, cannabinoid materials, and dietary supplements.

Exemplary of the many active ingredients suitable for transmucosal delivery are acetaminophen, amphetamine, aspirin, benzocaine, brompheniramine, buprenorphine, buspirone, butorphanol, caffeine, carbex, chlorpheniramine, clemastine, chromium, clotrimazole, cyclizine, cyclobenzaprine, dexbrompheniramine, dextromethorphan, dezocine, dibucaine, dihydroergotamine, dimenhydrinate, diphenhydramine, diphenoxylate, doxylamine, dyclonine, eldepryl, ephedrine, ergotamine, fentanyl, granisetron, guanifensin, hexobarbital, hydromorphone, hydroxyzine, ibuprofen, ketoprophen, levoprornazine, levorphanol, lidocaine, loperamide, d-methamphetamine, d,I-methamphetamine 1-methamphetamine, meclizine, menthol, methotirneprazine, miconazole, morphine, nalbuphine, naphazoline, naproxen sodium, naratriptan, nicotine, oxycodone, oxymetazoline, pentobarbital, peptide-medicants, pergolide, mesylate, pheniramine, phenobarbital, phentermine, phenylephrine, phenylpropanolamine, pilocarpine, promethazine, propylhexedrine, pseudoephedrine, protein-medicants, pyrilarnine, rizatriptan, salagen, scopalamine, secobarbital, selegiline, sumatriptan, tetracaine, tetrahydrocannabinol, tramadol, triclosan, tripolidine, zolmitriptan, pentobarbital, hexobarbital, secobarbital, phenobarbital, and zolpidem.

Exemplary of the active ingredient for dietary supplements suitable for transmucosal delivery are biotin, calcium, carnitine, choline, chromium, copper, creatine, fluorine, folate, inositol, iodine, iron, magnesium, manganese, molybdenum, niacin, niacinamide, pangamic add (Vitamin B15), pantothenic acid, para-aminobenzoic acid, phosphorus, potassium, protein, riboflavin, selenium, silicon, thiamin, tin, vanadium, Vitamin A, Vitamin B1, Vitamin 2, Vitamin 3, Vitamin B6, Vitamin B12, Vitamin C, Vitamin D, Vitamin E, Vitamin K, and zinc,

Examples of minerals that are available as active ingredients include, without limitation, calcium, magnesium, phosphorus, iron, zinc, iodine, selenium, potassium, copper, manganese, molybdenum and mixtures thereof. As is the case with vitamins, the amount of mineral or minerals present in the formulation is dependent on the particular mineral and is generally the USRDA for that mineral.

Examples of herbals that are available as active ingredients include, without limitation, echinacea, peppermint, licorice, goldenseal, panax pseudoginseng, grapeseed extract, bilberry, kava, ginko biloba, panax quinquefolium, Siberian ginseng, St. John's wort, bromelian, guglupids, hawthorn, garlic, ginger, angelica species, dandelion, goldenseal, and mixtures thereof, Further, examples of spices that are available as active ingredients include, without limitation, mustard, dillweed, cinnamon, garlic, black pepper, onion, sage, oregano, basil, cream of tartar, targon, cayenne pepper, red pepper, and mixtures thereof. In an example, the herbs can include cannabis materials, such as cannabinoids including tetrahydrocannabinol (THC), cannabidiol (CBD), cannabinol (CBN), or combinations thereof. This list of herbals and spices is for exemplary purposes and is not meant to be construed as limiting the inventive subject matter thereto.

Various combinations of active ingredients may be incorporated into single delivery systems suitable for transmucosal delivery. For example, a cough/cold chewing gum could have a cough suppressant, dextromethorphan, an antihistamine, e.g., diphenhydramine, and a decongestant, e.g., pseudoephedrine, in the same preparation. Combinations of medicants, dietary supplements and herbal products could also be incorporated into single delivery systems suitable for transmucosal delivery.

### EXAMPLES

### Example 1

Carbonated crystals including isomalt and carbon dioxide were placed in a pan at ambient temperature. Crystals were about 70% of the final product. Melted coconut oil at 85-90° F. was sprayed onto the crystals, to coat them evenly. Coconut oil was about 4% of the final product. The preblend included xylitol (carrier, about 15% of final product), flavors, colors, sucralose (sweetener), and caffeine and zinc gluconate (actives, at about 5% of final product). The preblend was mixed evenly to ensure consistent dosage of actives. While the coconut oil is still melted, the preblend was added to the pan at ambient temperature. Jets of cool, filtered air at 65-75° F. was sprayed into the pan for 10-30 minutes, to solidify the oil and trap the preblend, which ensures a consistent dosage of actives. The product was then ready to package.

### Example 2

Carbonated crystals including sugar, lactose, rice syrup, and carbon dioxide were placed in a pan at ambient temperature. Crystals were about 75% of final product. Melted coconut oil at 85-90° F. was sprayed onto the crystals, to coat them evenly. Coconut oil was about 5% of final product. The preblend included calcium carbonate (carrier 10% of final product), 14 vitamins and minerals, flavors, turmeric for color, and stevia (sweetener). The preblend was mixed evenly to ensure consistent dosage of actives. While the coconut oil was still melted, the preblend was added to the pan at ambient temperature. Jets of cool, filtered air at 65-75° F. were sprayed into the pan for 10-30 minutes, to solidify the oil and trap the preblend, which ensures a consistent dosage of actives. The product was then ready to package.

The minerals and vitamins used in Example 2 included calcium carbonate, vitamin A palmitate, ascorbic acid, d-l-alpha tocopheryl acetate, cholecalciferol, thiamin mononitrate, riboflavin, pyridoxine HCl, niacinamide, folic acid, biotin, pantothenic acid, cyanocobalamin, potassium iodide, zinc oxide.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

We claim:

1. A modified confectionary item comprising:
a confectionary item; and
a premix formulation coating a surface of the confectionary item, wherein the premix formulation includes a carrier and an active ingredient.

2. The modified confectionary item of claim 1, wherein the confectionary item includes at least one of a hard candy, chew candy, popping candy, mints, lozenges, gum, lollipop, and combinations thereof.

3. The modified confectionary item of claim 1, wherein the confectionary item includes isomalt.

4. The modified confectionary item of claim 1, wherein the active ingredient includes at least one of a pharmaceutical, an herbal ingredient, a vitamin, a mineral, and combinations thereof.

5. The modified confectionary item of claim 1, wherein the carrier includes at least one of xylitol, erythritol, and combinations thereof.

6. The modified confectionary item of claim 1, wherein the premix formulation includes at least one of a sugar, a flavor, a scent, a sweetener, a spice, and combinations thereof.

7. The modified confectionary item of claim 1, wherein the premix formulation includes at least one of antiadherents, binders, coatings, colors, disintegrants, flavors, glidants, lubricants, preservatives, sorbents, sweeteners, and combinations thereof.

8. A method of forming a modified confectionary item, the method comprising:
providing a confectionary item;
applying an oil coating to a surface of the confectionary item;
applying a premix formulation including an active ingredient and a carrier formulation to the oil coated confectionary item to form the modified confectionary item; and
drying the modified confectionary item.

9. The method of claim 8, wherein the premix formulation is in the form of a powder.

10. The method of claim 8, wherein the premix formulation is in the form of a liquid.

11. The method of claim 8, wherein the oil coating includes at least one of sunflower oil, palm kernel oil, coconut oil, and combinations thereof.

12. The method of claim 8, wherein drying includes applying forced air onto the modified confectionary item.

13. The method of claim 8, wherein drying includes applying forced air onto the modified confectionary item, wherein the forced air is a temperature below room temperature.

14. The method of claim 8, wherein applying the oil coating to the surface of the confectionary item includes spraying the oil coating to the surface of the confectionary item.

15. The method of claim 8, wherein the confectionary item includes at least one of a hard candy, chew candy, popping candy, mints, lozenges, gum, lollipop, and combinations thereof.

16. The method of claim 8, wherein the confectionary item includes carbonated candy.

17. The method of claim 8, wherein the active ingredient includes at least one of a pharmaceutical, a drug, an herbal ingredient, a vitamin, a mineral, and combinations thereof.

18. The method of claim 8, wherein the carrier includes at least one of xylitol, erythritol, and combinations thereof.

19. The method of claim 8, wherein the premix formulation includes at least one of a sugar, a flavor, a scent, a sweetener, a spice, and combinations thereof.
